(19) United States
(12) Patent Application Publication
(10) Pub. No.: US 2026/0252815 A1
(43) Pub. Date: Aug. 27, 2026

(54) METHOD AND DEVICE FOR DYNAMIC TOOL INTEGRATION OF LARGE LANGUAGE MODELS USING WEB ASSEMBLY

(71) Applicant: Vessl AI Korea Inc., Gwangju (KR)

(72) Inventors: Seok Ju HONG, Seoul (KR); Moon Kyung LIM, Yongin-si (KR)

(73) Assignee: Vessl AI Korea Inc., Gwangju (KR)

(21) Appl. No.: 19/290,970

(22) Filed: Aug. 5, 2025

(30) Foreign Application Priority Data
Feb. 24, 2025 (KR) 10-2025-0023693

(51) Int. Cl. G06F 40/40; G06F 16/903

(52) U.S. Cl. CPC G06F 40/40; G06F 16/90335

(57) ABSTRACT

Disclosed is a dynamic tool integration method of a large language model using a web assembly, which includes receiving a user query, selecting a driving tool based on the user query, downloading the driving tool capable of being driven in a web assembly environment, executing the driving tool in a web assembly runtime environment of a pocket framework, and generating an interactive answer to the user query based on an execution result of the driving tool, so as to be provided to a user.

### CROSS-REFERENCE TO RELATED APPLICATIONS

This application claims priority under 35 U.S.C. § 119 to Korean Patent Application No. 10-2025-0023693 filed on February 24, 2025, in the Korean Intellectual Property Office, the disclosures of which are incorporated by reference herein in their entireties.

### BACKGROUND

Embodiments of the present disclosure described herein relate to a method for integration and execution of an external tool in a large language model (LLM), and more particularly, relate to a technology for more efficient integration and stable execution of a dynamic tool by using a web assembly-based execution environment.

A large language model is widely used in AI agent systems which are capable of automating various tasks based on natural language processing and command generation functions.

Conventionally, a method of performing a task by using only the large language model itself has been studied. However, nowadays, there are being made attempts to handle more complex and diverse tasks by implementing interactions between external databases or external tools and the large language model to implement more accurate and diverse tasks.

Meanwhile, there are several limitations in integrating the external tools using an existing large language model. That is, for the integration of a specific AI framework with the external tools, the external tools should be dependent on the corresponding framework. For this reason, development for tool integration is necessarily required.

Accordingly, there is a growing need to integrate with the external tools more smoothly without being dependent on the environment of the large language model.

### SUMMARY

An embodiment of the present disclosure provides a technology for integration of a dynamic tool and a large language model using a web assembly, which is capable of integrating an external tool more efficiently and stably in a large language model system.

An embodiment of the present disclosure provides a technology for integration of a dynamic tool and a large language model using a web assembly, which is capable of simplifying and standardizing a tool integration process by using the web assembly regardless of a framework.

An embodiment of the present disclosure provides a technology for integration of a dynamic tool and a large language model using a web assembly, which is capable of providing a consistent execution experience by integrating a tool implemented with various programming languages and a web assembly environment.

Problems to be solved by the present disclosure are not limited to the above problems, and other problems not mentioned herein may be clearly understood from the specification and the accompanying drawings by one skilled in the art to which the present disclosure pertains.

According to an embodiment, a dynamic tool integration method of a large language model using a web assembly includes receiving a user query, selecting a driving tool based on the user query, downloading the driving tool capable of being driven in a web assembly environment, executing the driving tool in a web assembly runtime environment of a pocket framework, and generating an interactive answer to the user query based on an execution result of the driving tool, so as to be provided to a user.

The selecting of the driving tool based on the user query may include generating a query prompt for selecting the driving tool associated with the user query, providing the query prompt to the large language model, and selecting the driving tool based on an answer of the large language model.

The generating of the query prompt for selecting the driving tool associated with the user query may include generating a command for requesting a tool search based on the user query, and generating the query prompt including the user query and the command.

The downloading of the driving tool capable of being driven in the web assembly environment may include providing web assembly tool information capable of being driven on the web assembly, checking the driving tool in the web assembly tool information, and downloading the driving tool by using the web assembly tool information.

The web assembly tool information may include a list of web assembly tools capable of being driven on the web assembly, and download links of the web assembly tools.

The executing of the driving tool in the web assembly runtime environment of the pocket framework may include driving a browser on the pocket framework, and executing the driving tool through the browser.

The generating of the interactive answer to the user query based on the execution result of the driving tool so as to be provided to the user may include generating an answer prompt including the execution result of the driving tool and the user query, and providing the answer prompt to the large language model.

The generating of the interactive answer to the user query based on the execution result of the driving tool so as to be provided to the user may include receiving an interactive answer to the user query, which is generated from the large language model, and providing an answer to the user query based on the interactive answer.

According to an embodiment, a device for dynamic tool integration of a large language model using a web assembly may include at least one processor, and a memory that stores instructions. The instructions, when executed individually or collectively by the at least one processor, may cause the processor to receive a user query, to select a driving tool based one the user query, to download the driving tool capable of being driven in a web assembly environment, to execute the driving tool in a web assembly runtime environment of a pocket framework, and to generate an interactive answer to the user query based on an execution result of the driving tool, so as to be provided to a user.

Technical solutions of the present disclosure are not limited to the above solutions, and solutions which are not mentioned will be clearly understood by one skilled in the art to which the present disclosure pertains from the specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a diagram describing a dynamic tool integration device of a large language model using a web assembly, according to an embodiment of the present disclosure.

FIG. 2 is a diagram describing an operation of a dynamic tool integration device of a large language model using a web assembly, according to an embodiment of the present disclosure.

FIG. 3 is a flowchart describing a dynamic tool integration method of a large language model using a web assembly, according to an embodiment of the present disclosure.

FIG. 4 is a flowchart describing a method of selecting a driving tool based on a query of a user, according to an embodiment of the present disclosure.

FIG. 5 is a flowchart describing a method of downloading a driving tool in a web assembly environment, according to an embodiment of the present disclosure.

FIG. 6 is a flowchart describing a method of providing an interactive answer based on a driving tool execution result, according to an embodiment of the present disclosure.

FIG. 7 is a flowchart describing one scenario of a dynamic tool integration method of a large language model using a web assembly, according to an embodiment of the present disclosure.

FIG. 8 is a flowchart describing a method of generating a web assembly-based driving tool based on an alternative tool, according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when a component is referred to as being “directly connected” or “directly coupled” to another component, it should be understood that any other component is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, or parts or a combination thereof exists, but do not preclude the presence or addition of one or more other features, numbers, steps, operations, components, or parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

In the specification, a processor may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to a functional and/or structural combination of hardware for carrying out the technical idea of the present disclosure and/or software for driving the hardware.

Below, embodiments will be described in detail with reference to the accompanying drawings. However, the scope of the patent application is neither limited nor restricted by the embodiments. The same reference numerals/signs in the drawings denote the same members.

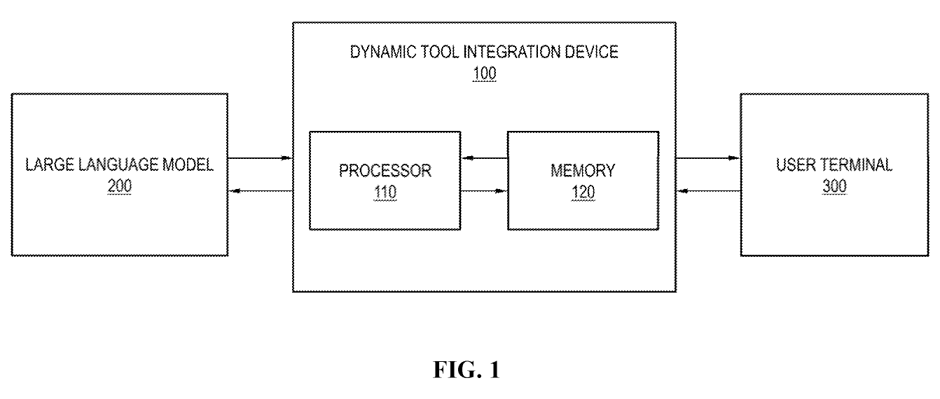

FIG. 1 is a diagram describing a dynamic tool integration device of a large language model using a web assembly, according to an embodiment of the present disclosure.

Referring to FIG. 1, a dynamic tool integration device of a large language model using a web assembly (hereinafter referred as to a “dynamic tool integration device 100”) may include a processor 110 and a memory 120.

Although not illustrated, the dynamic tool integration device 100 may further include a communication module for communicative connection with a large language model 200 and a user terminal 300 through wireless communication or wired communication. The communication module may include a communication circuitry.

The dynamic tool integration device 100 may be implemented with a service server, but the present disclosure is not limited thereto. For example, the dynamic tool integration device 100 may be provided as an independent server or an independent physical device, which is connected to a separate service server providing an artificial intelligence service.

An existing LLM system is often dependent on a specific language or platform during integration with a tool and suffers from security and dependency issues when an external tool is executed. In an embodiment of the present disclosure, to address the above issues, there is provided the dynamic tool integration device 100 capable of integrating an external tool efficiently and safely.

The dynamic tool integration device 100 may execute a tool based on a web assembly, thus minimizing linguistic restrictions and executing a code in an isolated environment.

The dynamic tool integration device 100 may provide a web assembly-based tool runtime development environment, and thus, a tool integration process may be simplified by using the web assembly regardless of a framework.

The dynamic tool integration device 100 may provide a consistent execution experience by integrating tools implemented by various programming languages into the web assembly, and thus, the linguistic restrictions may be solved.

The dynamic tool integration device 100 may execute even an unreliable tool in a safe environment of the web assembly, thus improving security and guaranteeing an isolated environment.

The dynamic tool integration device 100 may retrieve, install, or execute an appropriate tool automatically and dynamically if necessary, and thus, the possibility of implementing artificial general intelligence (AGI) may be extended.

The dynamic tool integration device 100 includes the processor 110 and the memory 120.

As an example, the processor 110 may include at least one of a microprocessor, a central processing unit, a processor core, a multi-core processor, a multiprocessor, an application-specific integrated circuit (ASIC), or a field programmable gate array (FPGA), but the present disclosure is not limited thereto.

The memory 120 may store instructions (or programs) executable by the processor 110. The memory 120 may include a volatile memory or a nonvolatile memory.

The volatile memory may be implemented with a dynamic random access memory (DRAM), a static random access memory (SRAM), a thyristor RAM (T-RAM), a zero capacitor RAM (Z-RAM), or a twin transistor RAM (TTRAM).

The nonvolatile memory may be implemented with an electrically erasable programmable read-only memory (EEPROM), a flash memory, a magnetic RAM (MRAM), a spin-transfer torque MRAM (STT-MRAM), a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

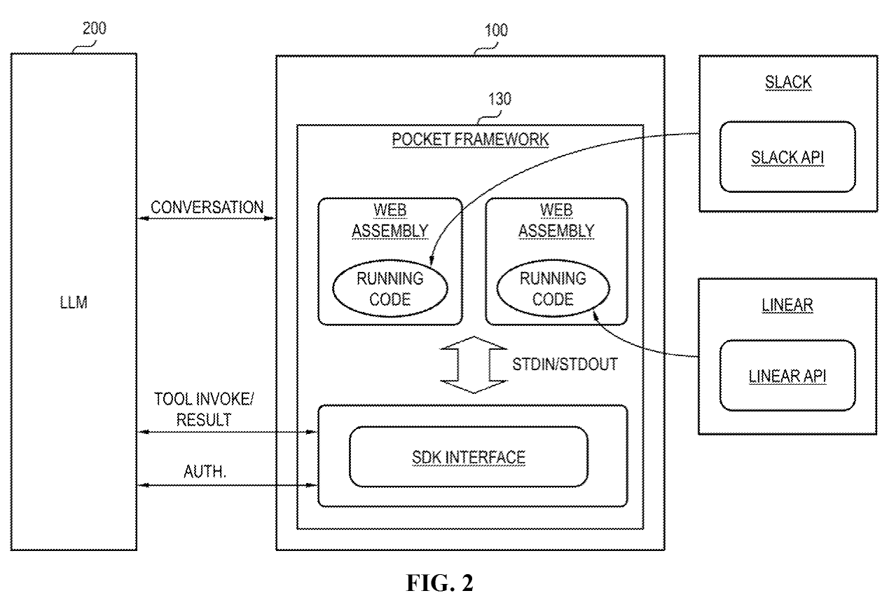

FIG. 2 is a diagram describing an operation of a dynamic tool integration device of a large language model using a web assembly, according to an embodiment of the present disclosure.

The dynamic tool integration device 100 includes a pocket framework 130 which is driven on the dynamic tool integration device 100. The pocket framework 130 may be referred to as a “pocket SDK”.

The pocket framework 130 may be a software development kit (SDK) which provides an execution environment based on a web assembly (Wasm) and is capable of dynamically integrating and managing various tools in the web assembly-based execution environment.

The web assembly environment of the pocket framework 130 provides an isolated execution environment. That is, tools may be executed independently of each other every web assembly runtime, and thus, security and performance may be improved.

The pocket framework 110 may dynamically obtain a driving tool from the outside and may inject the running tool into the web assembly environment so as to be executed. That is, the pocket framework 110 may include a dynamic tool injection function; through the dynamic tool injection function, the pocket framework 110 may provide a function of searching open source storage (e.g., GitHub) for an appropriate tool whenever a tool is required, so as to be automatically integrated and executed.

The pocket framework 130 may store and manage a tool manifest including a metadata file associated with each tool. The pocket framework 130 may automatically process tool management and tool execution setup based on the tool manifest.

As an example, a manifest file describing input data based on the JSON schema may be included in a tool directory. Authentication requirements for external open source storage and a web assembly file path may be defined in the manifest file.

Below, an external tool which is used to process a query of the user is called a driving tool. As an example, the large language model 200 may determine the driving tool corresponding to the user query.

The pocket framework 130 may obtain the driving tool from the external open source storage, and execute the driving tool in the web assembly environment. As an example, the pocket framework 130 may download a web assembly bytecode of a tool, and the installed tool may be registered to be used on the LLM workflow framework.

The pocket framework 130 may perform a tool execution process for driving tool execution. For example, the pocket framework 130 may check authentication information which is necessary to execute a tool and may provide an appropriate authentication/authorization method (e.g., Token or OAuth2) to the user. After the authentication, the pocket framework 130 may execute the driving tool in a browser environment (e.g., a headless mode browser) and may enable the execution of an HTML file including a web assembly code. The input data may be transferred to the driving tool after the LLM verifies the input data depending on the JSON schema defined in the manifest, and the execution result may be provided to the LLM workflow as a standard output.

The pocket framework 130 may include a dynamic tool injection system. The dynamic tool injection system performs the process of automatically retrieving, installing, and executing the driving tool. For dynamic tool injection, the pocket framework 130 may retrieve and install a tool automatically. As an example, when a driving tool does not exist currently, the pocket framework 110 may search the open source platform for an appropriate tool, may install the found tool, and may then integrate the found tool into the LLM workflow. The installed driving tool may be executed in the web assembly runtime environment and may be integrated into an existing workflow.

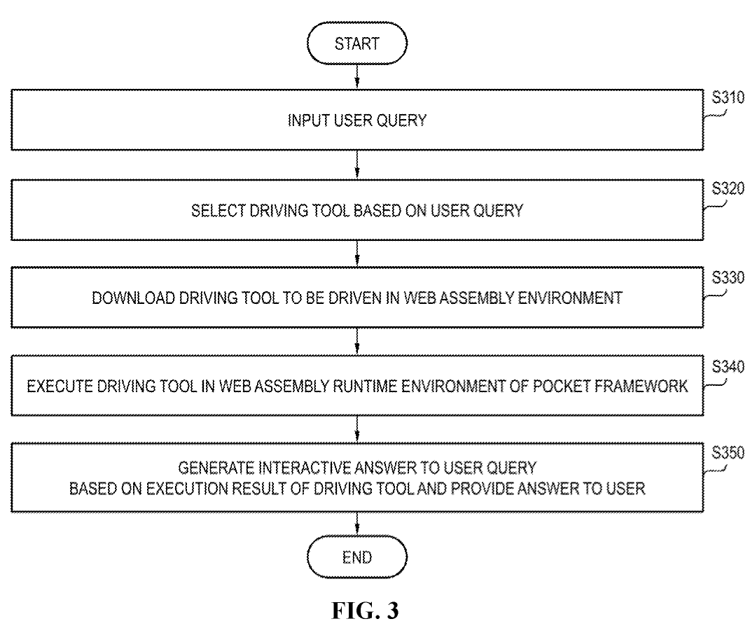

Various embodiments of a dynamic tool integration method which is performed by the dynamic tool integration device 100 will be described with reference to FIGS. 3 to 8.

FIG. 3 is a flowchart describing a dynamic tool integration method of a large language model using a web assembly, according to an embodiment of the present disclosure.

When a user query is input (S310), the dynamic tool integration device 100 may select a driving tool based on the user query (S320).

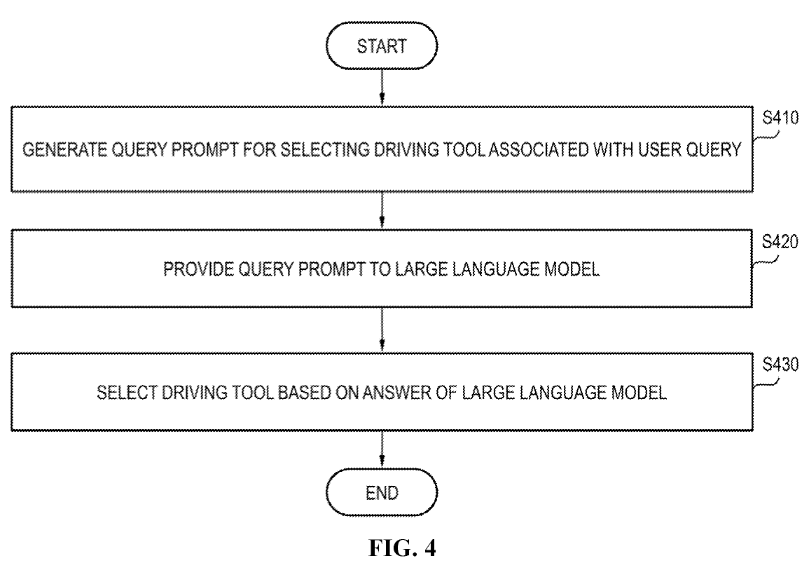

In an embodiment, the dynamic tool integration device 100 may select a necessary driving tool depending on the user query, by using the large language model 200. This embodiment will be described in detail with reference to FIG. 4.

When the driving tool is selected, the dynamic tool integration device 100 may download the driving tool capable of being driven in the web assembly environment (S330).

The dynamic tool integration device 100 may execute the driving tool in a web assembly runtime environment of a pocket framework (S340).

As an example, the dynamic tool integration device 100 may drive a browser on the pocket framework and may execute the driving tool in the web assembly runtime environment through the driven browser.

The dynamic tool integration device 100 may generate an interactive answer to the user query based on a result of executing the driving tool through the above process and may provide the interactive answer to the user (S350).

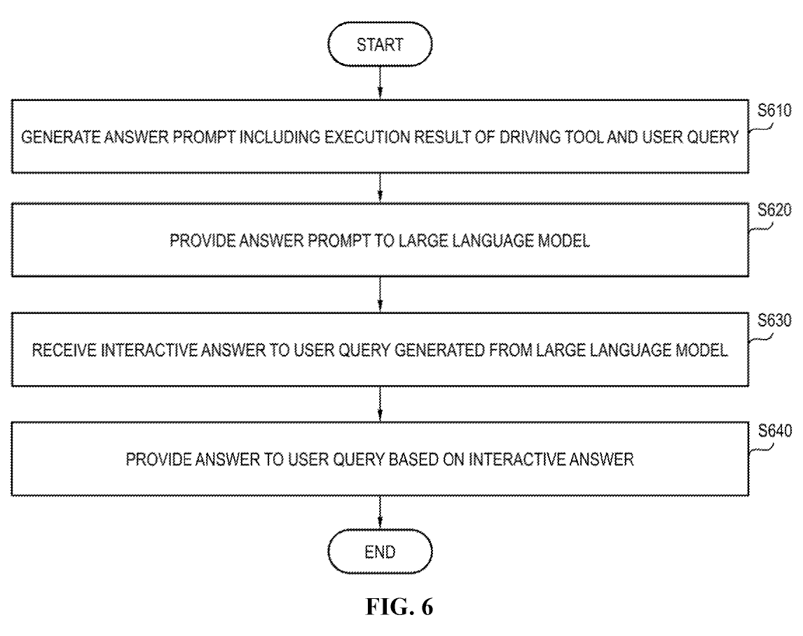

In an embodiment, the dynamic tool integration device 100 may generate the interactive answer to the user query by using the large language model 200, based on a result of the driving tool. This embodiment will be described in detail with reference to FIG. 6.

FIG. 4 is a flowchart describing a method of selecting a driving tool based on a query of a user, according to an embodiment of the present disclosure.

Referring to FIG. 4, the dynamic tool integration device 100 may generate a query prompt for selecting a driving tool associated with the user query (S410).

The query prompt which is a prompt provided to the large language model 200 as a query is a prompt for choosing a necessary tool from the user query by using the large language model 200.

In an embodiment, to generate the query prompt, the dynamic tool integration device 100 may generate a command for requesting tool search based on the user query. Afterwards, the dynamic tool integration device 100 may generate the query prompt including the user query and the command. For example, the dynamic tool integration device 100 may generate the command “Please check a user query and select a driving tool for performing the user query”. The dynamic tool integration device 100 may generate the query prompt including the user query and the above command.

The dynamic tool integration device 100 may provide the query prompt to the large language model 200 (S420) and may select a driving tool based on an answer of the large language model 200 (S430).

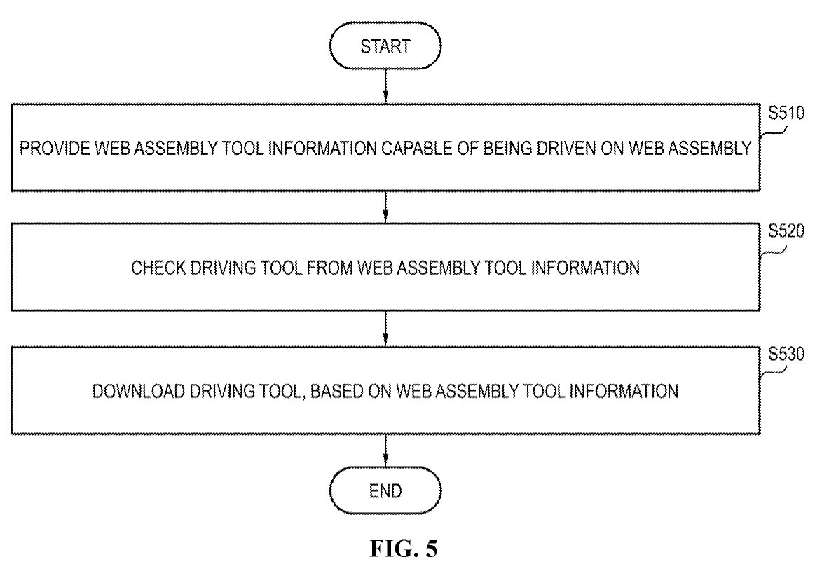

FIG. 5 is a flowchart describing a method of downloading a driving tool in a web assembly environment, according to an embodiment of the present disclosure.

Referring to FIG. 5, the dynamic tool integration device 100 may include web assembly tool information capable of being driven on the web assembly (S510). The dynamic tool integration device 100 may check the driving tool from the web assembly tool information (S520) and may download the driving tool by using the web assembly tool information (S530).

Herein, the web assembly tool information may include a list of web assembly tools capable of being driven on the web assembly and download links of the web assembly tools.

That is, the example in which the web assembly tool information which is information about a tool to be driven in the web assembly environment is built in advance or is obtained from the outside and the driving tool is then obtained by using the web assembly tool information is illustrated in FIG. 5.

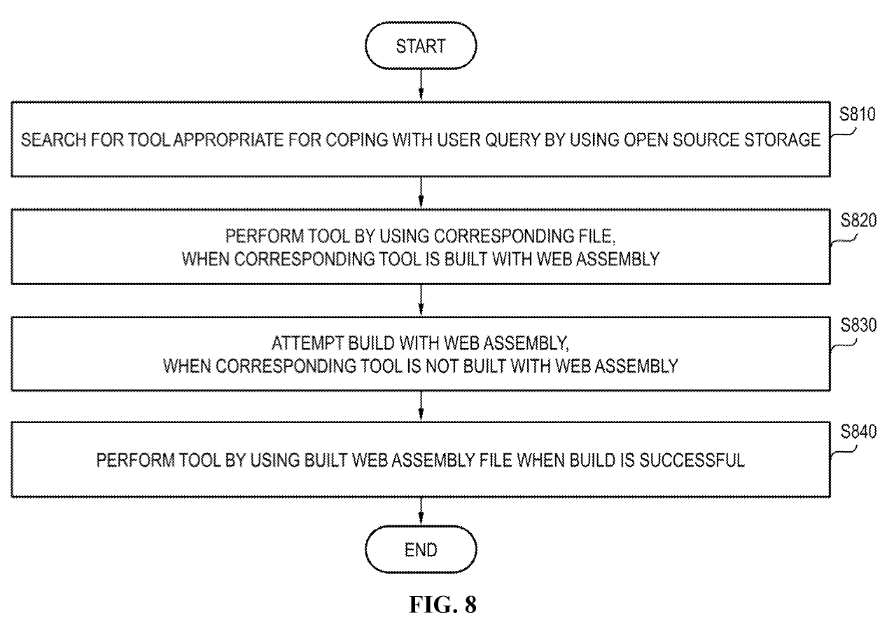

Meanwhile, the driving tool may be absent from the web assembly tool information; in this case, like an embodiment illustrated in FIG. 8, an embodiment in which the driving tool is generated based on an alternative tool may be used.

FIG. 6 is a flowchart describing a method of providing an interactive answer based on a driving tool execution result, according to an embodiment of the present disclosure.

Referring to FIG. 6, the dynamic tool integration device 100 may generate an answer prompt including an execution result of the driving tool and the user query (S610).

For example, when a tool execution plan comes from a large language model 200, the dynamic tool integration device 100 may perform an operation of searching for a tool corresponding to the tool execution plan and actually executing the found tool.

The dynamic tool integration device 100 may provide the answer prompt to the large language model (S620) and may receive the interactive answer generated from the large language model (S630).

The dynamic tool integration device 100 may provide the interactive answer to the user terminal 300 (S640).

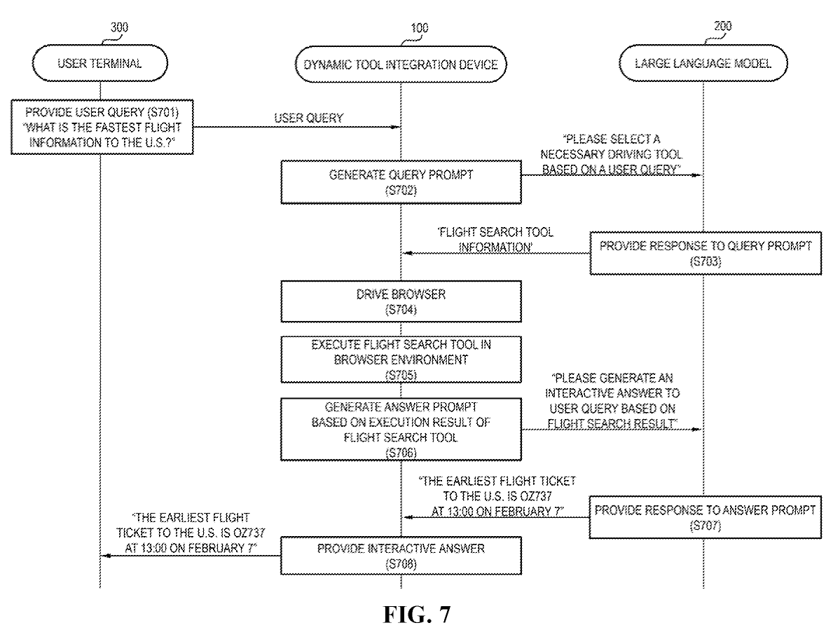

FIG. 7 is a flowchart describing one scenario of a dynamic tool integration method of a large language model using a web assembly, according to an embodiment of the present disclosure. An example of the dynamic tool integration method will be described with reference to FIG. 7.

The user terminal 300 may provide the user query to the dynamic tool integration device 100 (S701). The description will be given as the assumption that “What is the earliest flight information to the U.S.?” is provided as an example of the user query.

The dynamic tool integration device 100 may generate the query prompt to determine which tool is required based on the user query (S702). For example, the dynamic tool integration device 100 may generate the query prompt including a command “Please select a necessary driving tool based on a user query” and the user query and may query the query prompt to the large language model 200.

The large language model 200 may provide a response to the query prompt to the dynamic tool integration device 100. As an example of the response, an answer “a flight search tool is required” may be provided.

The dynamic tool integration device 100 may select a flight search tool as the driving tool and may perform a process for driving the flight search tool. In detail, the dynamic tool integration device 100 may drive the browser to build the web assembly runtime environment (S704) and may execute the flight search tool as the driving tool in the web assembly runtime environment after obtaining the flight search tool (S705).

To generate the interactive answer based on a result of the driving tool, the dynamic tool integration device 100 may generate the answer prompt by using the large language model 200 (S706). For example, the dynamic tool integration device 100 may generate the answer prompt “Please generate an interactive answer to a user query based on a flight search result” and may query the flight search result being an execution result of the dynamic tool and the user query to the large language model 200.

The large language model 200 may provide a response to the answer prompt to the dynamic tool integration device 100 (S707). As an example of the response, an answer “The earliest flight ticket to the U.S. is OZ737 at 13:00 on February 7” may be provided.

The dynamic tool integration device 100 may provide the interactive answer associated with the user query to the user terminal 300, based on the interactive answer provided from the large language model 200 (S708). For example, the dynamic tool integration device 100 may provide the user terminal 300 with the answer “The earliest flight ticket to the U.S. is OZ737 at 13:00 on February 7”.

FIG. 8 is a flowchart describing a method of generating a web assembly-based driving tool based on an alternative tool, according to an embodiment of the present disclosure.

An embodiment illustrated in FIG. 8 is associated with a method of generating a web assembly-based driving tool when the web assembly-based driving tool is not found.

The dynamic tool integration device 100 may search whether a tool appropriate for coping with the user query exists, by using open source storage such as Github (S810).

When the corresponding tool is built with the web assembly, the dynamic tool integration device 100 may perform the tool by using the corresponding file (S820).

Meanwhile, when the corresponding tool is not built with the web assembly, the dynamic tool integration device 100 may attempt the build with the web assembly (S830); when the build is successfully performed, the dynamic tool integration device 100 may perform the tool by using the built web assembly file (S840).

In another embodiment, the dynamic tool integration device 100 may search for a tool to be driven in the web assembly environment to determine whether the driving tool exists. For example, the search for the tool corresponding to the driving tool may be performed by using the above web assembly tool information.

When the tool is absent from the web assembly environment, the dynamic tool integration device 100 may search whether the tool corresponding to the driving tool exists in a second driving environment.

For example, when the web assembly-based tool is not found, to find the alternative tool, the dynamic tool integration device 100 may search executable tools for the alternative tool in a driving environment different from the web assembly as a target of a search range, for example, a native library or any other execution environment.

When the tool is found in the second driving environment, the dynamic tool integration device 100 may download the corresponding tool as the alternative tool. For example, in FIG. 7, when the flight search tool capable of being driven is found in the C environment, the dynamic tool integration device 100 may secure the flight search tool as the alternative tool.

The dynamic tool integration device 100 may dynamically compile the alternative tool into the web assembly to generate the driving tool.

For example, the dynamic tool integration device 100 may dynamically compile the alternative tool, that is, the flight search tool capable of being driven in the C environment into the web assembly. In some cases, the dynamic tool integration device 100 may generate the driving tool by automatically converting a code in runtime so as to be executable in the web assembly environment. To this end, the dynamic tool integration device 100 may perform code conversion automation processing. For the automatic code conversion, the dynamic tool integration device 100 may search the open source project or the external storage for a library and may convert the alternative tool of the C environment into the dynamic tool of the web assembly environment.

According to the above embodiment, even when the driving tool is absent from the web assembly environment, the driving tool may be generated based on the alternative tool in various execution environments, and thus, the flexibility of system may be secured. Also, the dynamic tool integration device 100 may automatically convert the code and may create the execution environment, allowing the user to conveniently performs tasks without direct setup.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g.; CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

According to embodiments, there are provided effects of increasing the efficiency of task and reinforcing security by integrally managing tools developed with various languages by using a web assembly-based isolated execution environment and automating a dynamic tool addition and execution process.

According to embodiments, there is provided an effect of providing a tool integration process regardless of a framework by using a web assembly, without separate development according to a kind of a framework.

According to embodiments, there is provided an effect of reinforcing security by executing an external tool in a safe execution environment of the web assembly.

Effects according to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. A dynamic tool integration method of a large language model using a web assembly, the method comprising:
receiving a user query;
selecting a driving tool based on the user query;
downloading the driving tool capable of being driven in a web assembly environment;
executing the driving tool in a web assembly runtime environment of a pocket framework; and
generating an interactive answer to the user query based on an execution result of the driving tool, so as to be provided to a user.

2. The method of claim 1, wherein the selecting of the driving tool based on the user query includes:
generating a query prompt for selecting the driving tool associated with the user query;
providing the query prompt to the large language model; and
selecting the driving tool based on an answer of the large language model.

3. The method of claim 2, wherein the generating of the query prompt for selecting the driving tool associated with the user query includes:
generating a command for requesting a tool search based on the user query; and
generating the query prompt including the user query and the command.

4. The method of claim 2, wherein the downloading of the driving tool capable of being driven in the web assembly environment includes:
providing web assembly tool information capable of being driven on the web assembly;
checking the driving tool in the web assembly tool information; and
downloading the driving tool by using the web assembly tool information.

5. The method of claim 4, wherein the web assembly tool information includes:
a list of web assembly tools capable of being driven on the web assembly; and
download links of the web assembly tools.

6. The method of claim 1, wherein the executing of the driving tool in the web assembly runtime environment of the pocket framework includes:
driving a browser on the pocket framework; and
executing the driving tool through the browser.

7. The method of claim 1, wherein the generating of the interactive answer to the user query based on the execution result of the driving tool so as to be provided to the user includes:
generating an answer prompt including the execution result of the driving tool and the user query; and
providing the answer prompt to the large language model.

8. The method of claim 7, wherein the generating of the interactive answer to the user query based on the execution result of the driving tool so as to be provided to the user includes:
receiving an interactive answer to the user query, which is generated from the large language model; and
providing an answer to the user query based on the interactive answer.

9. A device for dynamic tool integration of a large language model using a web assembly, comprising:
at least one processor; and
a memory configured to store instructions,
wherein the instructions, when executed individually or collectively by the at least one processor, cause the processor to:
receive a user query;
select a driving tool based one the user query;
download the driving tool capable of being driven in a web assembly environment;
execute the driving tool in a web assembly runtime environment of a pocket framework; and
generate an interactive answer to the user query based on an execution result of the driving tool, so as to be provided to a user.

10. A non-transitory computer-readable recording medium including instructions causing a computer to execute the method of claim 1.
